(19) United States
(12) Patent Application Publication
(10) Pub. No.: US 2015/0196059 A1
(43) Pub. Date: Jul. 16, 2015

(54) ELECTRONIC CIGARETTE ATOMIZER AND ELECTRONIC CIGARETTE USING THE SAME

(71) Applicant: Qiuming LIU, Shenzhen (CN)

(72) Inventor: Qiuming LIU, Shenzhen (CN)

(21) Appl. No.: 14/460,099

(22) Filed: Aug. 14, 2014

(30) Foreign Application Priority Data
Jan. 14, 2014 (CN) PCT/CN14/70569

(51) Int. Cl. A24F 47/00; H05B 3/03

(52) U.S. Cl. CPC A24F 47/008; H05B 3/03

(57) ABSTRACT

The present application discloses an electronic cigarette atomizer and an electronic cigarette using the electronic cigarette atomizer. The electronic cigarette atomizer comprises a plurality of atomizing assemblies, and each atomizing assembly includes at least one heating wire and defines a smoke channel configured to discharge smoke. The atomizing assemblies are all coaxial and thereby form a string, and the smoke channels of every two adjacent atomizing assemblies communicate with each other. The heating wires of all the atomizing assemblies are electrically connected successively, and the heating wire of each atomizing assembly is entirely or partially received in the smoke channel of the atomizing assembly. Pluralities of detachable connecting structure are mounted between every two adjacent atomizing assemblies to detachably connect every two adjacent atomizing assemblies with each other.

### CROSS REFERENCE TO RELATED APPLICATIONS

This application claims priority to International Application No. PCT/CN2014/070569, filed Jan. 14, 2014, which is hereby incorporated herein in its entirety by reference.

### FIELD OF THE INVENTION

The present application relates to the field of daily electronic products, and more particularly, relates to an electronic cigarette atomizer and an electronic cigarette using the same.

### BACKGROUND OF THE INVENTION

In the prior art, an electronic cigarette atomizer of an electronic cigarette usually includes only one atomizing assembly. The atomizing assembly usually includes an atomizing sleeve, a heating wire received in the atomizing sleeve, and a guide rope. The heating wire winds around the guide rope, and the guide rope is configured to transmit tobacco juice to the heating wire so as to use the heating wire to atomize the tobacco juice. The atomizing sleeve defines a smoke channel configured to discharge smoke generated by atomizing tobacco juice. However, the electronic cigarette atomizer can only generate little smoke when it works. Moreover, the amount of the smoke generated by the electronic cigarette atomizer cannot be adjusted. Furthermore, if the atomizing assembly malfunctions, the electronic cigarette atomizer cannot normally work.

### SUMMARY OF THE INVENTION

The present application is configured to solve this technical problem: aiming at the aforementioned defects of the electronic cigarette atomizer of the electronic cigarette in the prior art, an electronic cigarette atomizer that can generate a large amount of smoke, adjust the amount of the smoke, and replace malfunctioning atomizing assemblies, and an electronic cigarette using the electronic cigarette atomizer, are provided.

A technical solution of the present application configured to solve the aforementioned technical problem is to provide an electronic cigarette atomizer, which comprises a plurality of atomizing assemblies, each atomizing assembly including at least one heating wire and defining a smoke channel configured to discharge smoke;

wherein the atomizing assemblies are all coaxial and thereby form a string, and the smoke channels of every two adjacent atomizing assemblies communicate with each other; the heating wires of all the atomizing assemblies are electrically connected successively, and the heating wire of each atomizing assembly is entirely or partially received in the smoke channel of the atomizing assembly; a plurality of detachable connecting structures are mounted between every two adjacent atomizing assemblies to detachably connect every two adjacent atomizing assemblies with each other.

In the electronic cigarette atomizer of the present application, each atomizing assembly further includes an atomizing sleeve, a first electrode structure mounted on one end of the atomizing sleeve, and a second electrode structure mounted on the other end of the atomizing sleeve;

wherein the first electrode structure includes a first outer electrode mounted on the atomizing sleeve, and a first inner electrode mounted inside the first outer electrode; the second electrode structure includes a second outer electrode mounted on the atomizing sleeve, and a second inner electrode mounted inside the second outer electrode; both the first outer electrode and the second outer electrode are electrically connected to one end of the heating wire, and both the first inner electrode and the second inner electrode are electrically connected to the other end of the heating wire;

wherein when two adjacent atomizing assemblies are connected with each other, the first outer electrode and the first inner electrode of one atomizing assembly are electrically connected to the second outer electrode and the second inner electrode of the other atomizing assembly respectively.

In the electronic cigarette atomizer of the present application, each detachable connecting structure includes an outer thread formed on the first outer electrode of one atomizing assembly, and an inner thread formed in the second outer electrode of the other atomizing assembly; and the outer thread is screwed in the inner thread to form a threaded connection.

In the electronic cigarette atomizer of the present application, each detachable connecting structure includes a magnetic connecting member mounted between the first outer electrode and the second outer electrode, and the first outer electrode is connected to the second outer electrode by the magnetic connecting member.

In the electronic cigarette atomizer of the present application, each detachable connecting structure includes a buckle extending along a radial direction of an outer sidewall of the first outer electrode, and a guide groove and a limiting groove that are both formed on an inner sidewall of the second outer electrode; the guide groove is formed along an axial direction of the inner sidewall of the second outer electrode, and the limiting groove is formed along a circumference of the inner sidewall of the second outer electrode and communicates with the guide groove;

wherein, when two adjacent atomizing assemblies are connected with each other, the buckle of one atomizing assembly is aligned with the guide groove of the other atomizing assembly and inserted into the limiting groove of the other atomizing assembly, and any one of the two atomizing assemblies is rotated so as to lock the buckle in the limiting groove.

In the electronic cigarette atomizer of the present application, the electronic cigarette atomizer further includes a suction nozzle detachably mounted on one atomizing assembly that is positioned on a distal end of the string of the atomizing assemblies.

In the electronic cigarette atomizer of the present application, each atomizing assembly further includes an oil storage sleeve sheathed outside the atomizing sleeve, a first end cover mounted between one end of the oil storage sleeve and one end of the atomizing sleeve, and a second end cover mounted between the other end of the oil storage sleeve and the other end of the atomizing sleeve that are both away from the first end cover; each atomizing assembly further includes an oil storage member mounted inside the atomizing sleeve, and the atomizing sleeve defines an oil channel hole aligned with the oil storage member; the oil storage sleeve, the atomizing sleeve, the first end cover, and the second end cover cooperatively form oil storage space to store tobacco juice.

In the electronic cigarette atomizer of the present application, the first end cover defines an oil injection hole, and each atomizing assembly further includes a sealing assembly configured to seal the oil injection hole.

In the electronic cigarette atomizer of the present application, the electronic cigarette atomizer further includes a suction nozzle detachably mounted on one atomizing assembly that is positioned on a distal end of the string of the atomizing assemblies.

In the electronic cigarette atomizer of the present application, the electronic cigarette atomizer further includes an outer sleeve sheathed outside the atomizing assemblies, a third end cover mounted between one atomizing assembly that is positioned on one distal end of the string of the atomizing assemblies and the outer sleeve, and a suction nozzle mounted between another atomizing assembly that is positioned on the other distal end of the string of the atomizing assemblies and the outer sleeve; each atomizing assembly further includes an oil storage member mounted inside the atomizing sleeve, and the atomizing sleeve defines an oil channel hole aligned with the oil storage member; the outer sleeve, the atomizing assemblies, the third end cover, and the suction nozzle cooperatively form oil storage space to store tobacco juice.

The present application further provides an electronic cigarette, which comprises a plurality of atomizing assemblies and a battery assembly electrically connected to the atomizing assemblies, each atomizing assembly including at least one heating wire and defining a smoke channel configured to discharge smoke;

wherein the atomizing assemblies are all coaxial and thereby form a string, and the smoke channels of every two adjacent atomizing assemblies communicate with each other; the heating wires of all the atomizing assemblies are electrically connected successively, and the heating wire of each atomizing assembly is entirely or partially received in the smoke channel of the atomizing assembly; a plurality of detachable connecting structures are mounted between every two adjacent atomizing assemblies to detachably connect every two adjacent atomizing assembly with each other.

In the electronic cigarette of the present application, each atomizing assembly further includes an atomizing sleeve, a first electrode structure mounted on one end of the atomizing sleeve, and a second electrode structure mounted on the other end of the atomizing sleeve;

wherein the first electrode structure includes a first outer electrode mounted on the atomizing sleeve, and a first inner electrode mounted inside the first outer electrode; the second electrode structure includes a second outer electrode mounted on the atomizing sleeve, and a second inner electrode mounted inside the second outer electrode; both the first outer electrode and the second outer electrode are electrically connected to one end of the heating wire, and both the first inner electrode and the second inner electrode are electrically connected to the other end of the heating wire;

wherein when two adjacent atomizing assemblies are connected with each other, the first outer electrode and the first inner electrode of one atomizing assembly are electrically connected to the second outer electrode and the second inner electrode of the other atomizing assembly respectively.

In the electronic cigarette of the present application, each detachable connecting structure includes an outer thread formed on the first outer electrode of one atomizing assembly, and an inner thread formed in the second outer electrode of the other atomizing assembly; and the outer thread is screwed in the inner thread to form a threaded connection.

In the electronic cigarette of the present application, each detachable connecting structure includes a magnetic connecting member mounted between the first outer electrode and the second outer electrode, and the first outer electrode is connected to the second outer electrode by the magnetic connecting member.

In the electronic cigarette of the present application, each detachable connecting structure includes a buckle extending along a radial direction of an outer sidewall of the first outer electrode, and a guide groove and a limiting groove that are both formed on an inner sidewall of the second outer electrode; the guide groove is formed along an axial direction of the inner sidewall of the second outer electrode, and the limiting groove is formed along a circumference of the inner sidewall of the second outer electrode and communicates with the guide groove;

wherein when two adjacent atomizing assemblies are connected with each other, the buckle of one atomizing assembly is aligned with the guide groove of the other atomizing assembly and inserted into the limiting groove of the other atomizing assembly, and any one of the two atomizing assemblies is rotated so as to lock the buckle in the limiting groove.

In the electronic cigarette of the present application, the electronic cigarette further includes a suction nozzle detachably mounted on one atomizing assembly that is positioned on a distal end of the string of the atomizing assemblies.

In the electronic cigarette of the present application, each atomizing assembly further includes an oil storage sleeve sheathed outside the atomizing sleeve, a first end cover mounted between one end of the oil storage sleeve and one end of the atomizing sleeve, and a second end cover mounted between the other end of the oil storage sleeve and the other end of the atomizing sleeve that are both away from the first end cover; each atomizing assembly further includes an oil storage member mounted inside the atomizing sleeve, and the atomizing sleeve defines an oil channel hole aligned with the oil storage member; the oil storage sleeve, the atomizing sleeve, the first end cover, and the second end cover cooperatively form oil storage space to store tobacco juice.

In the electronic cigarette of the present application, the first end cover defines an oil injection hole, and each atomizing assembly further includes a sealing assembly configured to seal the oil injection hole.

In the electronic cigarette of the present application, the electronic cigarette further includes a suction nozzle detachably mounted on one atomizing assembly that is positioned on a distal end of the string of the atomizing assemblies.

In the electronic cigarette of the present application, the electronic cigarette further includes an outer sleeve sheathed outside the atomizing assemblies, a third end cover mounted between one atomizing assembly that is positioned on one distal end of the string of the atomizing assemblies and the outer sleeve, and a suction nozzle mounted between another atomizing assembly that is positioned on the other distal end of the string of the atomizing assemblies and the outer sleeve; each atomizing assembly further includes an oil storage member mounted inside the atomizing sleeve, and the atomizing sleeve defines an oil channel hole aligned with the oil storage member; the outer sleeve, the atomizing assemblies, the third end cover, and the suction nozzle cooperatively form oil storage space to store tobacco juice.

By implementing the electronic cigarette atomizer and the electronic cigarette of the present application, the following advantages can be achieved:

a. The electronic cigarette atomizer includes a plurality of coaxial atomizing assemblies, the smoke channels of every two adjacent atomizing assemblies communicate with each other, and the heating wire of each atomizing assembly is entirely or partially received in the smoke channel. Thus, the electronic cigarette atomizer can generate a large amount of smoke when it works. In use, smoke generated by each atomizing assembly enters a mouth cavity of a user via the intercommunicated smoke channels. When smoke generated by one atomizing assembly that is away from the suction nozzle and containing tobacco juice particles flows through another atomizing assembly that is close to the suction nozzle, the heating wire of the atomizing assembly that is close to the suction nozzle heats and atomizes the tobacco juice particles again, and thus the whole smoke amount is further increased. Moreover, the electronic cigarette atomizer can effectively prevent the tobacco juice from condensing and further prevent the user from inhaling the tobacco juice, and thus the user's experience can be enhanced.

b. The coaxial atomizing assemblies form a compact structure, and there is no additional space containing air in the structure. In use, the atomized smoke directly enters the mouth cavity of the user via the intercommunicated smoking channels. Since the smoke is not diluted by air, it has a high concentration. In this way, the user can obtain much smoke and a high smoke concentration by using a small smoking intensity, and thus the user's experience can be enhanced.

c. The plurality of atomizing assemblies are interconnected by detachable connecting structures, and thus the operations for assembling the plurality of atomizing assemblies together are simple. Each atomizing assembly can be used and replaced independently, and thus the user can choose the number of the atomizing assemblies according to his/her own requirement to achieve the effect of adjusting the amount of the smoke. Moreover, when one atomizing assembly malfunctions, it can be easily detected and replaced. Therefore, the electronic cigarette atomizer is easy to use.

d. The user himself/herself can adjust desired tobacco juice tastes by the combinations of different atomizing assemblies containing tobacco juice in various tastes. Thus, the electronic cigarette atomizer can meet personalized needs of the user, and can be adjusted simply and easily, so that the user's experience can be further enhanced.

### BRIEF DESCRIPTION OF THE DRAWINGS

FIG. 1 is a schematic view of a stereo structure of an electronic cigarette atomizer, in accordance with a first preferred embodiment of the present application.

FIG. 2 is an exploded view of the electronic cigarette atomizer shown in FIG. 1.

FIG. 3 is an internal structural view of the electronic cigarette atomizer shown in FIG. 1.

FIG. 4 is an enlarged view of the part A shown in FIG. 3.

FIG. 5 is a circuit principle diagram of heating wires of the electronic cigarette atomizer shown in FIG. 1, wherein the heating wires are connected in parallel.

FIG. 6 is an exploded view of an atomizing assembly of an electronic cigarette atomizer, in accordance with a second preferred embodiment of the present application.

FIG. 7 is an internal structural view of the atomizing assembly of the electronic cigarette atomizer shown in FIG. 6.

FIG. 8 is an enlarged view of the part B shown in FIG. 7.

FIG. 9 is an exploded view of an atomizing assembly of an electronic cigarette atomizer, in accordance with a third preferred embodiment of the present application.

FIG. 10 is an internal structural view of the atomizing assembly of the electronic cigarette atomizer shown in FIG. 9.

FIG. 11 is an enlarged view of the part C shown in FIG. 9.

FIG. 12 is a schematic view of a stereo structure of an electronic cigarette atomizer, in accordance with a fourth preferred embodiment of the present application.

FIG. 13 is an exploded view of the electronic cigarette atomizer shown in FIG. 12.

FIG. 14 is a stereo structural view of an atomizing assembly of the electronic cigarette atomizer shown in FIG. 12.

FIG. 15 is an internal structural view of the electronic cigarette atomizer shown in FIG. 12.

FIG. 16 is an exploded view of the atomizing assembly of the electronic cigarette atomizer shown in FIG. 12.

FIG. 17 is a schematic view of a stereo structure of an electronic cigarette atomizer, in accordance with a fifth preferred embodiment of the present application.

FIG. 18 is an internal structural view of the electronic cigarette atomizer shown in FIG. 17.

FIG. 19 is a schematic view of a stereo structure of an electronic cigarette, in accordance with one preferred embodiment of the present application.

### DETAILED DESCRIPTION OF THE PREFERRED EMBODIMENT

In order to understand the technical features, purpose and the effect of the present invention more clearly, the preferred specific embodiments of the present invention will be described referring to the drawings.

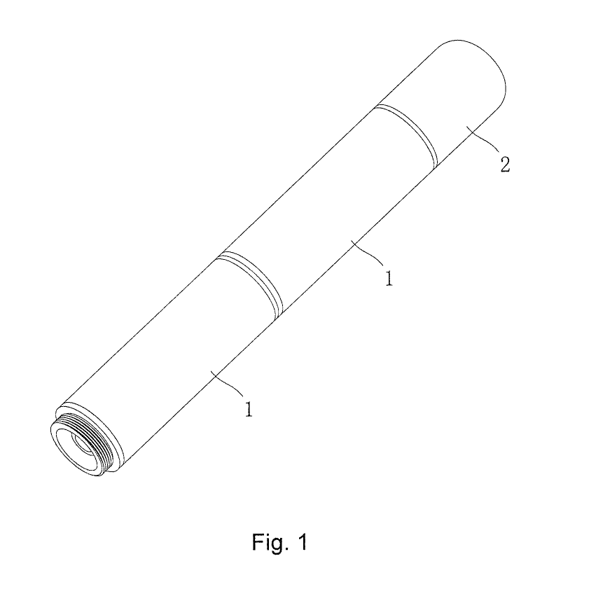

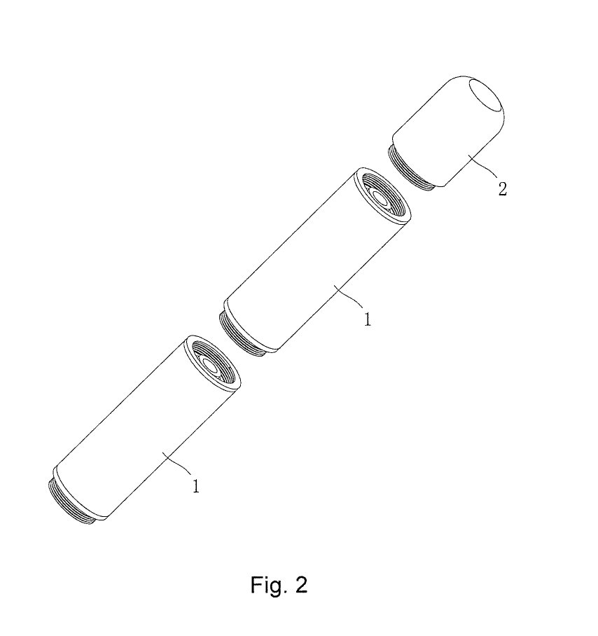

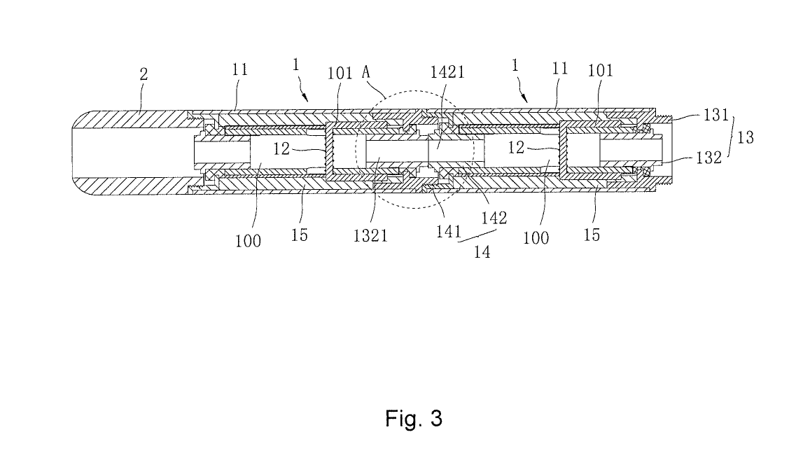

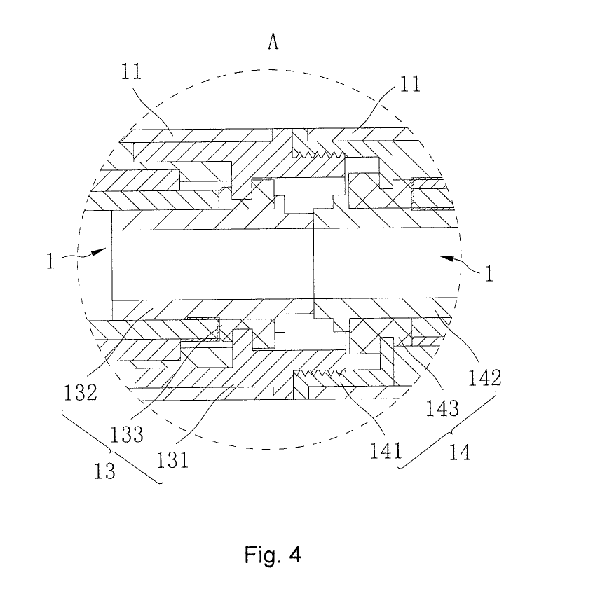

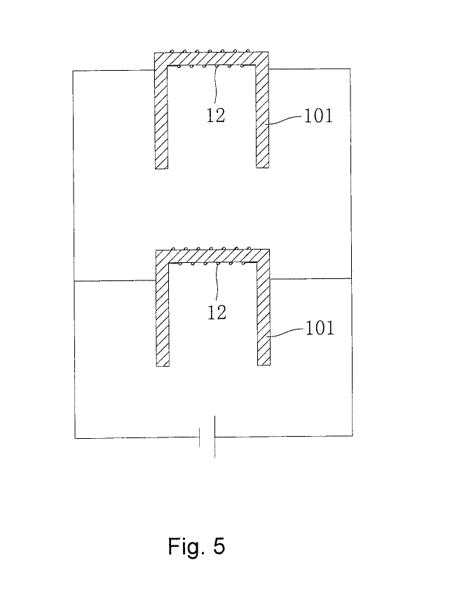

As shown in FIG. 1, FIG. 2, FIG. 3, FIG. 4, FIG. 5, a first preferred embodiment of the present application provides an electronic cigarette atomizer, which includes a plurality of atomizing assemblies 1 and a suction nozzle 2. Wherein each atomizing assembly 1 includes a heating wire 12, and a guide rope 101 configured to transmit tobacco juice to the heating wire 12 so as to use the heating wire 12 to atomize the tobacco juice. The heating wire 12 is entirely or partially received in a smoke channel 100 defined in the atomizing assembly 1. When the heating wire 12 works, the electronic cigarette atomizer generates smoke for being inhaled by users; and the smoke is discharged via the smoke channel 100. In this embodiment, the number of the atomizing assemblies 1 is at least two, and the atomizing assemblies 1 are all coaxial and thereby form a string. The smoke channels 100 of every two adjacent ones of the atomizing assemblies 1 communicate with each other, all of the atomizing assemblies 1 have the same structures, and the heating wires 12 of the atomizing assemblies 1 are electrically connected successively. A plurality of detachable connecting structures is mounted between every two adjacent atomizing assemblies 1, and the detachable connecting structures detachably connect all the atomizing assemblies 1 in turn. The suction nozzle 2 is detachably mounted on an outward end of an atomizing assembly 1 that is positioned on one distal end of the string of the atomizing assemblies 1, and a battery assembly (not shown) is connected to an outward end of another atomizing assembly 1 that is positioned on the other distal end of the string of the atomizing assemblies 1. The battery assembly is used to supply electric power to the plurality of atomizing assemblies 1 so as to drive the atomizing assemblies 1 to work and generate smoke. When the electronic cigarette atomizer works, the plurality of atomizing assemblies 1 works synchronously, so that the electronic cigarette atomizer generates a large amount of smoke. Moreover, due to the use of the detachable connecting structures, the operation for assembling the plurality of atomizing assemblies 1 together is simple, and each atomizing assembly 1 can be used and replaced independently. Thus, a user can choose the number of the atomizing assemblies 1 according to his/her own requirement to achieve the effect of adjusting the amount of the smoke, the amount of the smoke and the concentration of the smoke can be enhanced, and the user can be prevented from inhaling the tobacco juice. Furthermore, the user himself/herself can adjust desired tobacco juice tastes by the combinations of the atomizing assemblies 1 containing different tobacco juices in various tastes. Finally, when one atomizing assembly 1 malfunctions, it can be easily detected and replaced. Thus, the electronic cigarette atomizer can meet personalized needs of the user and enhance the user's experience. In this embodiment, the number of the atomizing assemblies 1 is two. The heating wires 12 of the two atomizing assemblies 1 are connected in parallel, and each heating wire 12 winds around a guide rope 101. The circuit principle diagram is shown in FIG. 5. Since the two heating wires 12 are connected in parallel, if any one of the two atomizing assemblies 1 malfunction, the electronic cigarette atomizer can still be normally used although the malfunctioning atomizing assembly 1 is not detached. In other embodiments, the number of the atomizing assemblies 1 can also be other numbers, such as three, four, and others. Each of the atomizing assemblies 1 can also include a plurality of heating wires 12. When the plurality of atomizing assemblies 1 are assembled together, the heating wires 12 of the plurality of atomizing assemblies 1 can also be connected in series.

Particularly, as shown in FIG. 3 and FIG. 4, each atomizing assembly 1 includes an atomizing sleeve 11, a heating wire 12, a first electrode structure 13, a second electrode structure 14, and an oil storage member 15. Wherein the atomizing sleeve 11 is substantially a hollow pipe structure. The heating wire 12 and the oil storage member 15 are mounted inside the atomizing sleeve 11. The oil storage member 15 is an oil storage cotton structure configured to store tobacco juice. When the heating wire 12 works, the tobacco juice stored in the oil storage member 15 is guided out by the guide rope 101, and then is atomized by the heating wire 12 to generate smoke. The first electrode structure 13 is mounted on one end of the atomizing sleeve 11, and the second electrode structure 14 is mounted on the other end of the atomizing sleeve 11, that is, the end of the atomizing sleeve 11 that is away from the first electrode structure 13.

As shown in FIG. 3 and FIG. 4, the first electrode structure 13 can be used to electrically connect to the battery assembly, and also can be used to electrically connect to the second electrode structure 14 of another atomizing assembly 1. The first electrode structure 13 includes a first outer electrode 131, a first inner electrode 132, and a first insulating member 133. The first outer electrode 131 is substantially a hollow cylinder structure, and is mounted on an end of the atomizing sleeve 11 that is away from the second electrode structure 14. The first inner electrode 132 is substantially a hollow cylinder structure too, and is mounted inside the first outer electrode 131. The first inner electrode 132 defines a first air hole 1321 configured to enable air flow to pass therein, and the first air hole 1321 extends along an axial direction of the first inner electrode 132. The first insulating member 133 is substantially an annular structure, and is mounted between the first outer electrode 131 and the first inner electrode 132 to insulate the first outer electrode 131 from the first inner electrode 132.

As shown in FIG. 3 and FIG. 4, the second electrode structure 14 can be used to connect to the suction nozzle 2, and can also be used to electrically connect to the first electrode structure 13 of another atomizing assembly 1. The second electrode structure 14 includes a second outer electrode 141, a second inner electrode 142, and a second insulating member 143. The second outer electrode 141 is substantially a hollow cylinder structure, and is mounted on an end of the atomizing sleeve 11 that is away from the first electrode structure 13. The second inner electrode 142 is substantially a hollow cylinder structure too, and is mounted inside the second outer electrode 141. The second inner electrode 142 defines a second air hole 1421 configured to enable air flow to pass therein. The second air hole 1421 extends along an axial direction of the second inner electrode 142, and is communicated with the first air hole 1321 via the smoke channel 100. In this embodiment, an inner diameter of the first air hole 1321 is equal to an inner diameter of the second air hole 1421. The second insulating member 143 is substantially an annular structure, and is mounted between the second outer electrode 141 and the second inner electrode 142 to insulate the second outer electrode 141 from the second inner electrode 142. In each atomizing assembly 1, both the first outer electrode 131 and the second outer electrode 141 are electrically connected to one end of the heating wire 12, and both the first inner electrode 132 and the second inner electrode 142 are electrically connected to the other end of the heating wire 12. In this embodiment, the two ends of the heating wire 12 are separately electrically connected to the first electrode structure 13 and the second electrode structure 14 by electronic wires; however, the connecting method is not limited here. For example, in other embodiments, the atomizing sleeve 11 can be made of metal material, and the heating wire 12 can be electrically connected to the first electrode structure 13 and the second electrode structure 14 by the atomizing sleeve 11. When two of the atomizing assemblies 1 are electrically connected with each other, the first outer electrode 131 and the first inner electrode 132 of one atomizing assembly 1 are electrically connected to the second outer electrode 141 and the second inner electrode 142 of the other atomizing assembly 1 respectively. In this embodiment, the first outer electrode 131 of one atomizing assembly 1 is screwed in the second outer electrode 141 of the other atomizing assembly 1 to form the electrical connection, and the first inner electrode 132 of one atomizing assembly 1 abuts against the second inner electrode 142 of the other atomizing assembly 1 to form the electrical connection.

As shown in FIG. 3 and FIG. 4, in this embodiment, each of the detachable connecting structures mounted between every two adjacent atomizing assemblies 1 includes an outer thread formed on the first outer electrode 131 of one atomizing assembly 1, and an inner thread formed in the second outer electrode 141 of the other atomizing assembly 1. The outer thread is screwed in the inner thread to form a threaded connection, so that the two adjacent atomizing assemblies 1 are detachably connected together, and the first outer electrode 131 of one atomizing assembly 1 is electrically connected to the second outer electrode 141 of the other atomizing assembly 1. In other embodiments of the present application, the detachable connecting structure can also include an inner thread formed in the first outer electrode 131 and an outer thread formed on the second outer electrode 141 to screw in the inner thread. In these embodiments, the detachable connecting structures are threaded connection structures, which are simple in structure and easy to operate when the atomizing assemblies 1 are disassembled. The suction nozzle 2 is detachably mounted on one end of an atomizing assembly 1 that is positioned on a distal end of the string of the atomizing assemblies 1, and one end of the suction nozzle 2 is provided with an outer thread screwed in the inner thread of the second outer electrode 141 of the atomizing assembly 1, so that the operations for mounting and detaching the suction nozzle 2 are easy.

In assembly of the electronic cigarette atomizer, the two atomizing assemblies 1 can be assembled together at first, and then the suction nozzle 2 is mounted on one atomizing assembly 1. If a user wants to use only one atomizing assembly 1, he/she only needs to detach the other assembly 1. Since the electronic cigarette atomizer has the structure including the two atomizing assemblies 1, when the electronic cigarette atomizer of this embodiment works, it can generate more smoke than an electronic cigarette atomizer in the prior art that has only one atomizing assembly. Moreover, the two atomizing assemblies 1 are interconnected by the detachable connecting structures, and thus the operations for assembling the two atomizing assemblies 1 together are simple. Each of the two atomizing assemblies 1 can be used and replaced independently; and thus the user can choose the number of the atomizing assemblies 1 according to his/her own requirement to achieve the effect of adjusting the amount of the smoke. In this way, the electronic cigarette atomizer can meet personalized needs of the user and enhance the user's experience.

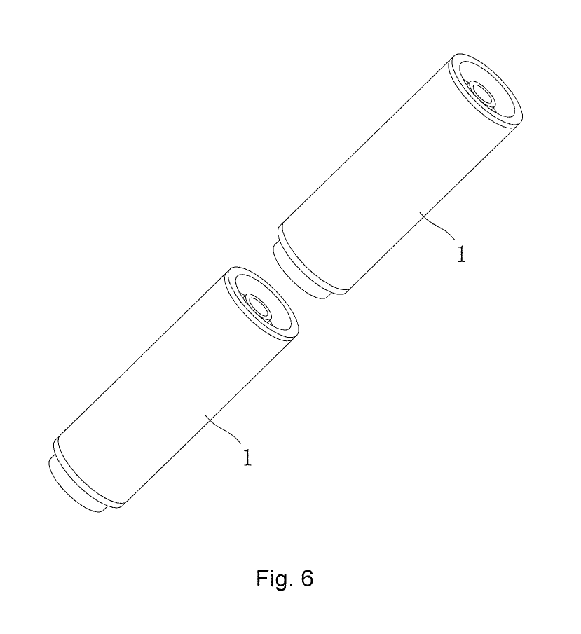

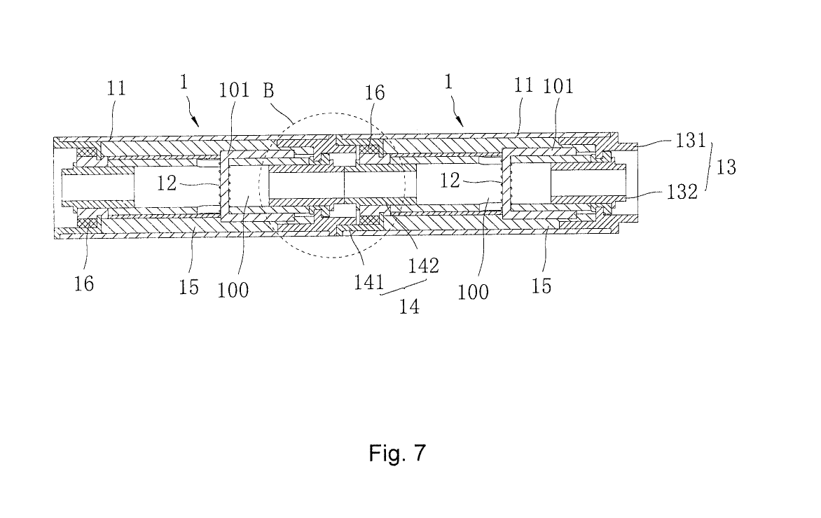

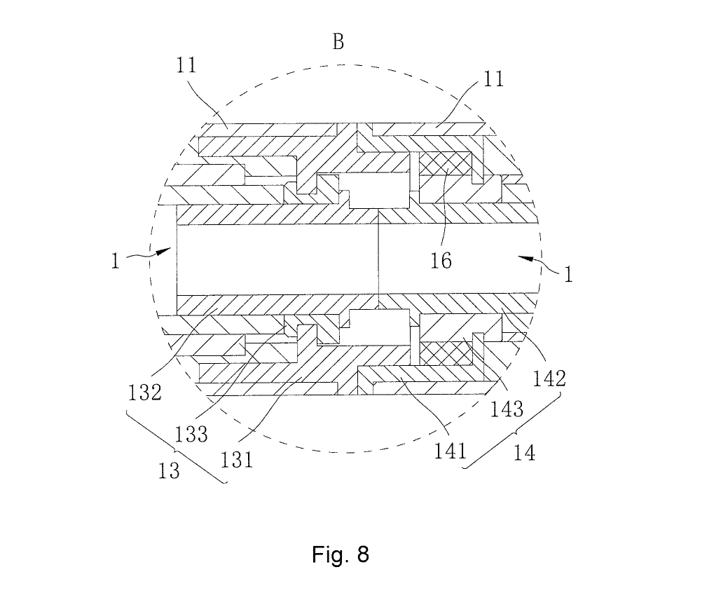

As shown in FIG. 6, FIG. 7, and FIG. 8, a second preferred embodiment of the present application provides an electronic cigarette atomizer, which differs from the first preferred embodiment in the detachable connecting structures mounted between adjacent ones of the atomizing assemblies 1. In this embodiment, each of the detachable connecting structures includes a magnetic connecting member 16 mounted between the first outer electrode 131 and the second outer electrode 141, and the first outer electrode 131 is connected to the second outer electrode 141 by the magnetic connecting member 16. The magnetic connecting member 16 is substantially a hollow cylinder structure, and is made of magnet. The magnetic connecting member 16 is fixedly mounted between the second outer electrode 141 and the second insulating member 143. The first outer electrode 131 is made of magnetic material, and the first outer electrode 131 and the magnetic connecting member 16 attract each other and are connected together due to magnetic force. In this way, every two adjacent atomizing assemblies 1 are detachably connected together. In this embodiment, adjacent atomizing assemblies 1 are detachably connected together by the magnetic connecting members 16, which is simple in structure. Furthermore, operations for detach the atomizing assemblies 1 are easier.

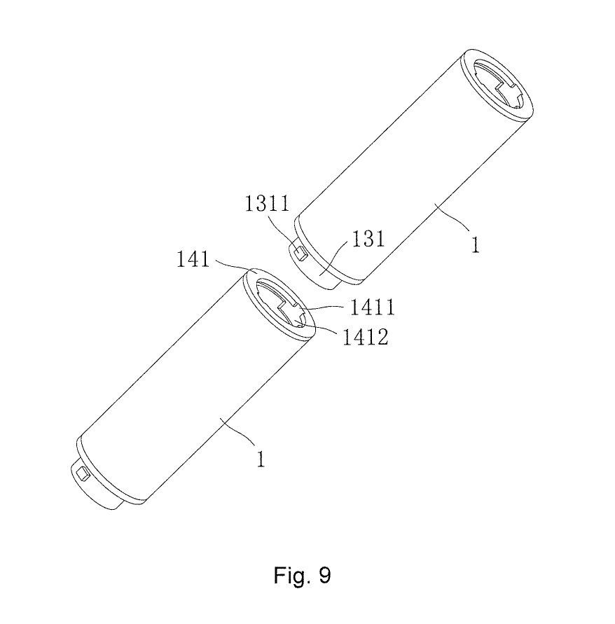

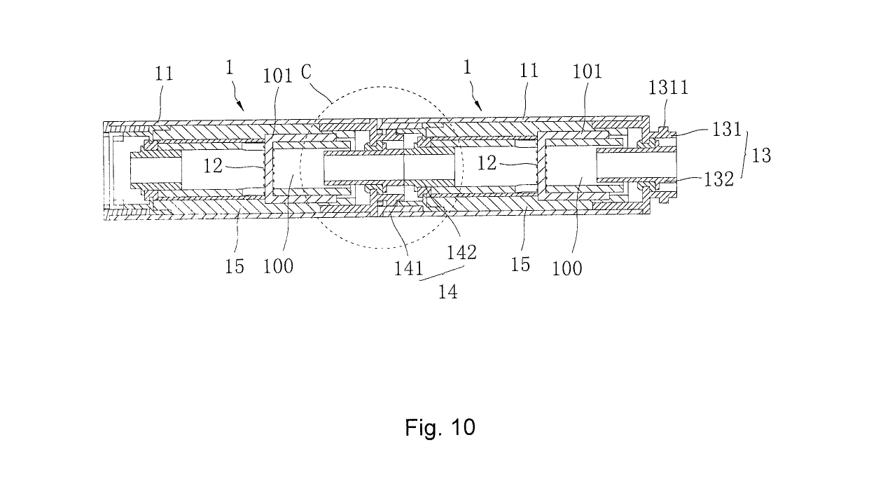

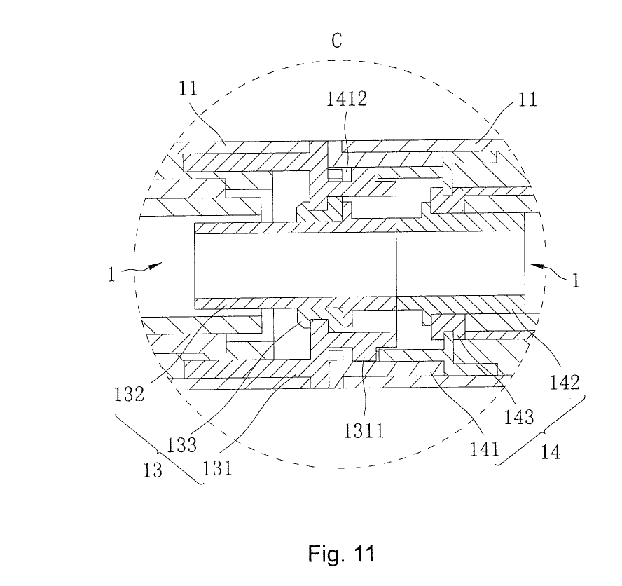

As shown in FIG. 9, FIG. 10, and FIG. 11, a third preferred embodiment of the present application provides an electronic cigarette atomizer, which differs from the first preferred embodiment in the detachable connecting structures mounted between adjacent ones of the atomizing assemblies 1, too. In this embodiment, when two adjacent atomizing assemblies 1 are connected with each other, the first outer electrode 131 of one atomizing assembly 1 is sleeved and fixed inside the second outer electrode 141 of the other atomizing assembly 1. Each of the detachable connecting structures includes a buckle 1311 extending along a radial direction of an outer sidewall of the first outer electrode 131, and a guide groove 1411 and a limiting groove 1412 that are both formed on an inner sidewall of the second outer electrode 141. Wherein the guide groove 1411 is formed along an axial direction of the inner sidewall of the second outer electrode 141, and the limiting groove 1412 is formed along a circumference of the inner sidewall of the second outer electrode 141 and communicates with the guide groove 1411.

As shown in FIG. 9, when two atomizing assemblies 1 are assembled together, the buckle 1311 of one atomizing assembly 1 is aligned with the guide groove 1411 of the other atomizing assembly 1 and inserted into the limiting groove 1412 of the other atomizing assembly 1, then, any one of the two atomizing assemblies 1 is rotated so as to lock the buckle 1311 in the limiting groove 1412. In this embodiment, the detachable connections between adjacent atomizing assemblies 1 are formed by the method of rotation buckling. The detachable connections are simple in structure, have high stability to connect adjacent atomizing assemblies 1 with each other, and are easy to operate when detaching the atomizing assemblies 1.

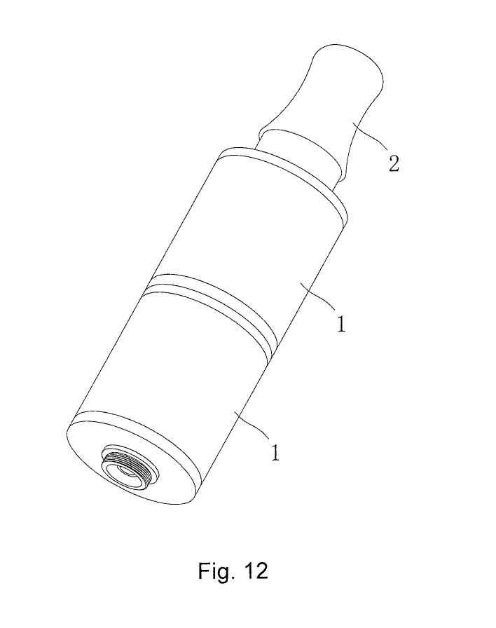

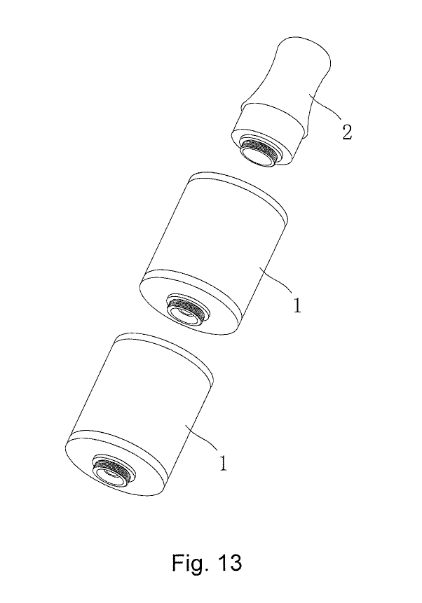

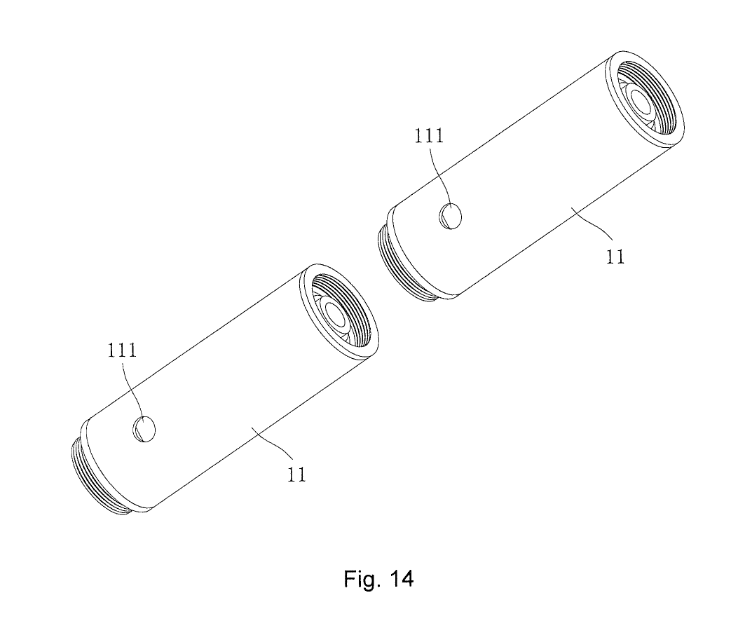

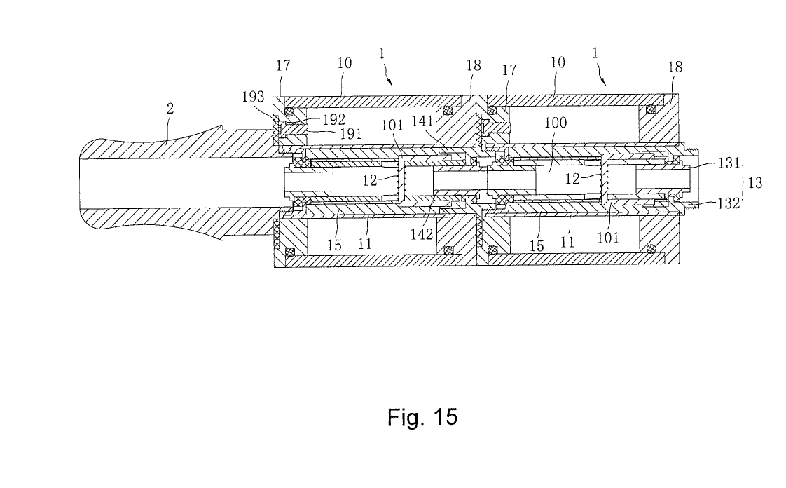

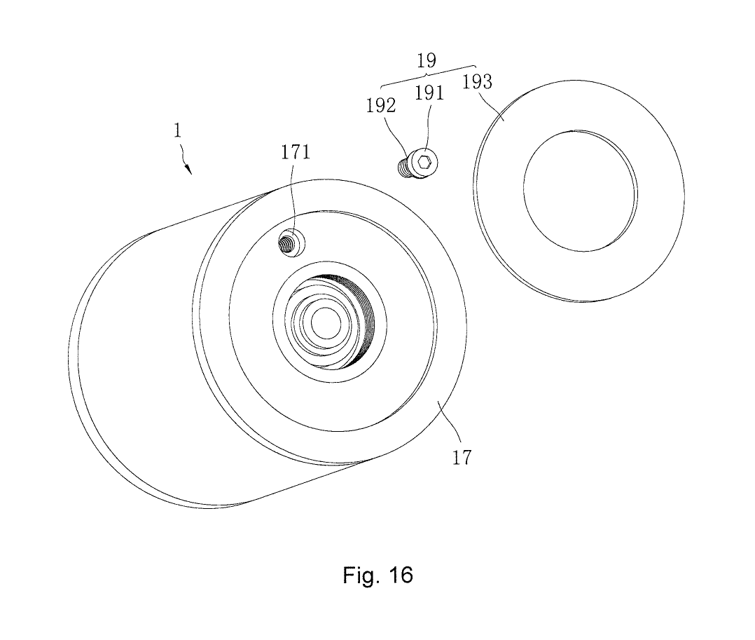

As shown in FIG. 12, FIG. 13, FIG. 14, FIG. 15, and FIG. 16, a fourth preferred embodiment of the present application provides an electronic cigarette atomizer, which differs from the first preferred embodiment in the structure of the atomizing assemblies 1. Tobacco juice can be added into the atomizing assemblies 1, so that the atomizing assemblies 1 can be repeatedly used for many times. In this embodiment, each atomizing assembly 1 further includes an oil storage sleeve 10, a first end cover 17, and a second end cover 18. The oil storage sleeve 10 is substantially a hollow pipe structure, and is sheathed outside the atomizing sleeve 11. An outer diameter of the oil storage sleeve 10 is larger than an outer diameter of the atomizing sleeve 11, and a length of the oil storage sleeve 10 is substantially equal to a length of atomizing sleeve 11. The first end cover 17 is substantially a hollow cylinder structure, and is mounted between one end of the oil storage sleeve 10 and one end of the atomizing sleeve 11. The second end cover 18 is substantially a hollow cylinder structure too, and is mounted between the other end of the oil storage sleeve 10 and the other end of the atomizing sleeve 11 that are both away from the first end cover 17. The atomizing sleeve 11 defines an oil channel hole 111 aligned with the oil storage member 15. The oil storage sleeve 10, the atomizing sleeve 11, the first end cover 17, and the second end cover 18 cooperatively form oil storage space to store tobacco juice.

In this embodiment, the first end cover 17 defines an oil injection hole 171, and each atomizing assembly 1 further includes a sealing assembly 19 configured to seal the oil injection hole 171. The sealing assembly 19 includes a sealing member 191, a sealing gasket 192, and a sealing washer 193. In this embodiment, the sealing member 191 is a screw fastener, and the oil injection hole 171 is a threaded hole, correspondingly. The sealing member 191 is inserted in the oil injection hole 171 to seal the oil injection hole 171. The sealing gasket 192 is substantially an annular structure, and is sheathed on an outer sidewall of the sealing member 191. The sealing gasket 192 is mounted between the sealing member 191 and the oil injection hole 171. The sealing washer 193 is substantially an annular structure too, and is mounted on one end of the first end cover 17 to further seal the oil injection hole 171. In this embodiment, tobacco juice can be added into each atomizing assembly 1, and thus each atomizing assembly 1 can be repeatedly used for many times. In this way, the service life of the electronic cigarette atomizer can be increased, and the use of the electronic cigarette atomizer can cost less.

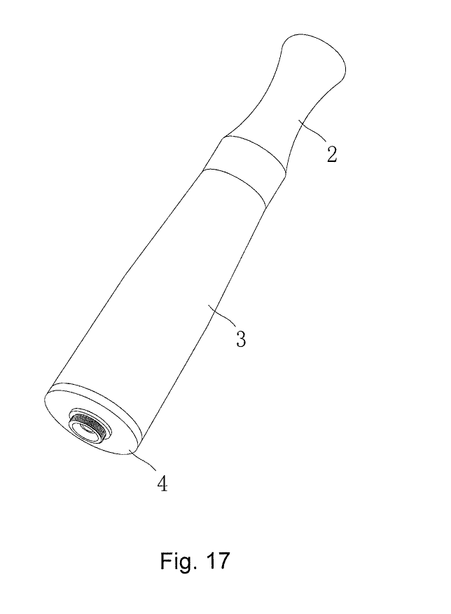

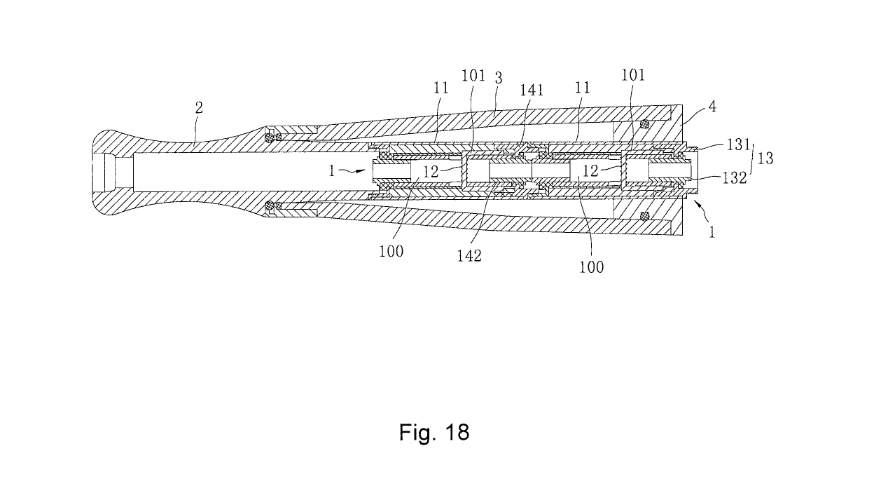

As shown in FIG. 17 and FIG. 18, a fifth preferred embodiment of the present application provides an electronic cigarette atomizer, which differs from the first preferred embodiment in that the electronic cigarette atomizer of the fifth preferred embodiment can store more tobacco juice. In this embodiment, the electronic cigarette atomizer further includes an outer sleeve 3 and a third end cover 4. The outer sleeve 3 is substantially a hollow pipe structure, and is sheathed outside the plurality of atomizing assemblies 1. An outer diameter of the outer sleeve 3 is larger than an outer diameter of each atomizing sleeve 11, and a length of the outer sleeve 3 is slightly larger than a total length of the atomizing sleeves 11 of the plurality of atomizing assemblies 1. The third end cover 4 is substantially a hollow cylinder structure, and is mounted between an end of one of the atomizing assemblies 1 that is positioned on a distal end of the string of the atomizing assemblies 1 and an end of the outer sleeve 3. The atomizing sleeve 11 defines an oil channel hole 111 aligned with the oil storage member 15. The outer sleeve 3, the plurality of atomizing assemblies 1, the third end cover 4, and the suction nozzle 2 cooperatively form oil storage space to store tobacco juice.

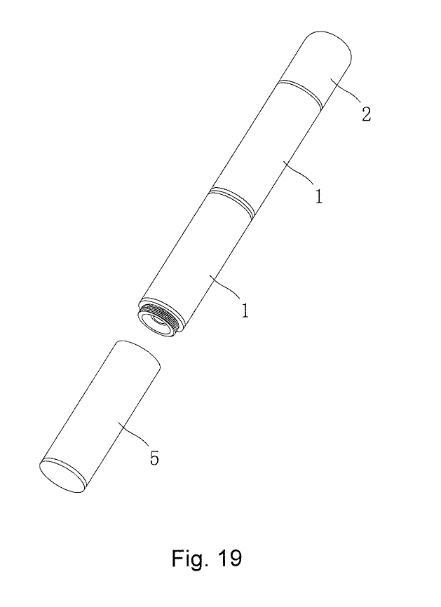

As shown in FIG. 19, based on the structures of the aforementioned electronic cigarette atomizers, the present application further provides an electronic cigarette, which includes an electronic cigarette atomizer of any one of the aforementioned embodiments and a battery assembly 5 electrically connected to the electronic cigarette atomizer. Since the electronic cigarette atomizer has the structure including at least two atomizing assemblies 1, compared with an electronic cigarette atomizer in the prior art that has only one atomizing assembly 1, the electronic cigarette can also achieve the technical effect as detailed above.

In conclusion, the electronic cigarette atomizers and the electronic cigarette of the embodiments of the present application can achieve the following technical effects:

a. The electronic cigarette atomizer includes a plurality of coaxial atomizing assemblies 1, the smoke channels 100 of every two adjacent atomizing assemblies 1 communicate with each other, and the heating wire 12 of each atomizing assembly 1 is entirely or partially received in the smoke channel 100. Thus, the electronic cigarette atomizer can generate a large amount of smoke when it works. In use, smoke generated by each atomizing assembly 1 enters a mouth cavity of a user via the intercommunicated smoke channels 100. When smoke generated by one atomizing assembly 1 that is away from the suction nozzle 2 and containing tobacco juice particles flows through another one atomizing assembly 1 that is close to the suction nozzle 2, the heating wire 12 of the atomizing assembly 1 that is close to the suction nozzle 2 heats and atomizes the tobacco juice particles again, and thus the whole smoke amount is further increased. Moreover, the electronic cigarette atomizer can effectively prevent the tobacco juice from condensing and further prevent the user from inhaling the tobacco juice, and thus the user's experience can be enhanced.

b. The coaxial atomizing assemblies 1 form a compact structure, and there is no additional space containing air in the structure. In use, the atomized smoke directly enters the mouth cavity of the user via the intercommunicated smoking channels 100. Since the smoke is not diluted by air, it has a high concentration. In this way, the user can obtain much smoke and a high smoke concentration by using a small smoking intensity, and thus the user's experience can be enhanced.

c. The plurality of atomizing assemblies 1 are interconnected by detachable connecting structures, and thus the operations for assembling the plurality of atomizing assemblies 1 together are simple. Each atomizing assembly 1 can be used and replaced independently, and thus the user can choose the number of the atomizing assemblies 1 according to his/her own requirement to achieve the effect of adjusting the amount of the smoke. Moreover, when one atomizing assembly 1 malfunctions, it can be easily detected and replaced. Therefore, the electronic cigarette atomizer is easy to use.

d. The user himself/herself can adjust desired tobacco juice tastes by the combinations of atomizing assemblies 1 containing tobacco juice in various tastes. Thus, the electronic cigarette atomizer can meet personalized needs of the user, and can be adjusted simply and easily, so that the user's experience can be further enhanced.

While the present invention has been described with the drawings to preferred embodiments which is merely a hint rather than a limit, it will be understood by those skilled in the art that various changes may be made and equivalents may be substituted without departing from the scope of the present invention. But all the changes will be included within the scope of the appended claims.

What is claimed is:

1. An electronic cigarette atomizer comprising a plurality of atomizing assemblies, each atomizing assembly including at least one heating wire and defining a smoke channel configured to discharge smoke;
wherein the atomizing assemblies are all coaxial and thereby form a string, and the smoke channels of every two adjacent atomizing assemblies communicate with each other; the heating wires of all the atomizing assemblies are electrically connected successively, and the heating wire of each atomizing assembly is entirely or partially received in the smoke channel of the atomizing assembly; a plurality of detachable connecting structures are mounted between every two adjacent atomizing assemblies to detachably connect every two adjacent atomizing assemblies with each other.

2. The electronic cigarette atomizer according to claim 1, wherein each atomizing assembly further includes an atomizing sleeve, a first electrode structure mounted on one end of the atomizing sleeve, and a second electrode structure mounted on the other end of the atomizing sleeve;
wherein the first electrode structure includes a first outer electrode mounted on the atomizing sleeve, and a first inner electrode mounted inside the first outer electrode; the second electrode structure includes a second outer electrode mounted on the atomizing sleeve, and a second inner electrode mounted inside the second outer electrode; both the first outer electrode and the second outer electrode are electrically connected to one end of the heating wire, and both the first inner electrode and the second inner electrode are electrically connected to the other end of the heating wire;
wherein, when two adjacent atomizing assemblies are connected with each other, the first outer electrode and the first inner electrode of one atomizing assembly are electrically connected with the second outer electrode and the second inner electrode of the other atomizing assembly respectively.

3. The electronic cigarette atomizer according to claim 2, wherein each detachable connecting structure includes an outer thread formed on the first outer electrode of one atomizing assembly, and an inner thread formed in the second outer electrode of the other atomizing assembly; and the outer thread is screwed in the inner thread to form a threaded connection.

4. The electronic cigarette atomizer according to claim 2, wherein each detachable connecting structure includes a magnetic connecting member mounted between the first outer electrode and the second outer electrode, and the first outer electrode is connected to the second outer electrode by the magnetic connecting member.

5. The electronic cigarette atomizer according to claim 2, wherein each detachable connecting structure includes a buckle extending along a radial direction of an outer sidewall of the first outer electrode, and a guide groove and a limiting groove that are both formed on an inner sidewall of the second outer electrode; the guide groove is formed along an axial direction of the inner sidewall of the second outer electrode, and the limiting groove is formed along a circumference of the inner sidewall of the second outer electrode and communicates with the guide groove;
wherein when two adjacent atomizing assemblies are connected with each other, the buckle of one atomizing assembly is aligned with the guide groove of the other atomizing assembly and inserted into the limiting groove of the other atomizing assembly, and any one of the two atomizing assemblies is rotated so as to lock the buckle in the limiting groove.

6. The electronic cigarette atomizer according to claim 2, wherein the electronic cigarette atomizer further includes a suction nozzle detachably mounted on one atomizing assembly that is positioned on a distal end of the string of the atomizing assemblies.

7. The electronic cigarette atomizer according to claim 2, wherein each atomizing assembly further includes an oil storage sleeve sheathed outside the atomizing sleeve, a first end cover mounted between one end of the oil storage sleeve and one end of the atomizing sleeve, and a second end cover mounted between the other end of the oil storage sleeve and the other end of the atomizing sleeve that are both away from the first end cover; each atomizing assembly further includes an oil storage member mounted inside the atomizing sleeve, and the atomizing sleeve defines an oil channel hole aligned with the oil storage member; the oil storage sleeve, the atomizing sleeve, the first end cover, and the second end cover cooperatively form oil storage space to store tobacco juice.

8. The electronic cigarette atomizer according to claim 7, wherein the first end cover defines an oil injection hole and each atomizing assembly further includes a sealing assembly configured to seal the oil injection hole.

9. The electronic cigarette atomizer according to claim 7, wherein the electronic cigarette atomizer further includes a suction nozzle detachably mounted on one atomizing assembly that is positioned on a distal end of the string of the atomizing assemblies.

10. The electronic cigarette atomizer according to claim 2, wherein the electronic cigarette atomizer further includes an outer sleeve sheathed outside the atomizing assemblies, a third end cover mounted between one atomizing assembly that is positioned on one distal end of the string of the atomizing assemblies and the outer sleeve, and a suction nozzle mounted between another atomizing assembly that is positioned on the other distal end of the string of the atomizing assemblies and the outer sleeve; each atomizing assembly further includes an oil storage member mounted inside the atomizing sleeve, and the atomizing sleeve defines an oil channel hole aligned with the oil storage member; the outer sleeve, the atomizing assemblies, the third end cover, and the suction nozzle cooperatively form oil storage space to store tobacco juice.

11. An electronic cigarette comprising a plurality of atomizing assemblies and a battery assembly electrically connected to the atomizing assemblies, each atomizing assembly including at least one heating wire and defining a smoke channel configured to discharge smoke;
wherein the atomizing assemblies are all coaxial and thereby form a string, and the smoke channels of every two adjacent atomizing assemblies communicate with each other; the heating wires of all the atomizing assemblies are electrically connected successively, and the heating wire of each atomizing assembly is entirely or partially received in the smoke channel of the atomizing assembly; a plurality of detachable connecting structures are mounted between every two adjacent atomizing assemblies to detachably connect every two adjacent atomizing assemblies with each other.

12. The electronic cigarette according to claim 11, wherein each atomizing assembly further includes an atomizing sleeve, a first electrode structure mounted on one end of the atomizing sleeve, and a second electrode structure mounted on the other end of the atomizing sleeve;
wherein the first electrode structure includes a first outer electrode mounted on the atomizing sleeve, and a first inner electrode mounted inside the first outer electrode; the second electrode structure includes a second outer electrode mounted on the atomizing sleeve, and a second inner electrode mounted inside the second outer electrode; both the first outer electrode and the second outer electrode are electrically connected to one end of the heating wire, and both the first inner electrode and the second inner electrode are electrically connected to the other end of the heating wire;
wherein, when two adjacent atomizing assemblies are connected with each other, the first outer electrode and the first inner electrode of one atomizing assembly are electrically connected to the second outer electrode and the second inner electrode of the other atomizing assembly respectively.

13. The electronic cigarette according to claim 12, wherein each detachable connecting structure includes an outer thread formed on the first outer electrode of one atomizing assembly, and an inner thread formed in the second outer electrode of the other atomizing assembly; and the outer thread is screwed in the inner thread to form a threaded connection.

14. The electronic cigarette according to claim 12, wherein each detachable connecting structure includes a magnetic connecting member mounted between the first outer electrode and the second outer electrode, and the first outer electrode is connected to the second outer electrode by the magnetic connecting member.

15. The electronic cigarette according to claim 12, wherein each detachable connecting structure includes a buckle extending along a radial direction of an outer sidewall of the first outer electrode, and a guide groove and a limiting groove that are both formed on an inner sidewall of the second outer electrode; the guide groove is formed along an axial direction of the inner sidewall of the second outer electrode, and the limiting groove is formed along a circumference of the inner sidewall of the second outer electrode and communicates with the guide groove;
wherein, when two adjacent atomizing assemblies are connected with each other, the buckle of one atomizing assembly is aligned with the guide groove of the other atomizing assembly and inserted into the limiting groove of the other atomizing assembly, and any one of the two atomizing assemblies is rotated so as to lock the buckle in the limiting groove.

16. The electronic cigarette according to claim 12, wherein the electronic cigarette further includes a suction nozzle detachably mounted on one atomizing assembly that is positioned on a distal end of the string of the atomizing assemblies.

17. The electronic cigarette according to claim 12, wherein each atomizing assembly further includes an oil storage sleeve sheathed outside the atomizing sleeve, a first end cover mounted between one end of the oil storage sleeve and one end of the atomizing sleeve, and a second end cover mounted between the other end of the oil storage sleeve and the other end of the atomizing sleeve that are both away from the first end cover; each atomizing assembly further includes an oil storage member mounted inside the atomizing sleeve, and the atomizing sleeve defines an oil channel hole aligned with the oil storage member; the oil storage sleeve, the atomizing sleeve, the first end cover, and the second end cover cooperatively form oil storage space to store tobacco juice.

18. The electronic cigarette according to claim 17, wherein the first end cover defines an oil injection hole; and each atomizing assembly further includes a sealing assembly configured to seal the oil injection hole.

19. The electronic cigarette according to claim 17, wherein the electronic cigarette further includes a suction nozzle detachably mounted on one atomizing assembly that is positioned on a distal end of the string of the atomizing assemblies.

20. The electronic cigarette according to claim 12, wherein the electronic cigarette further includes an outer sleeve sheathed outside the atomizing assemblies, a third end cover mounted between one atomizing assembly that is positioned on one distal end of the string of the atomizing assemblies and the outer sleeve, and a suction nozzle mounted between another atomizing assembly that is positioned on the other distal end of the string of the atomizing assemblies and the outer sleeve; each atomizing assembly further includes an oil storage member mounted inside the atomizing sleeve, and the atomizing sleeve defines an oil channel hole aligned with the oil storage member; the outer sleeve, the atomizing assemblies, the third end cover, and the suction nozzle cooperatively form oil storage space to store tobacco juice.
